(19) United States
(12) Patent Application Publication
(10) Pub. No.: US 2024/0314595 A1
(43) Pub. Date: Sep. 19, 2024

(54) MINIMIZATION OF SERVICE INTERRUPTION

(71) Applicant: INTERDIGITAL PATENT HOLDINGS, INC., Wilmington, DE (US)

(72) Inventors: Michael STARSINIC, Newtown, PA (US); Quang LY, North Wales, PA (US); Catalina MLADIN, Hatboro, PA (US); Jiwan NINGLEKHU, Royersford, PA (US); Pascal ADJAKPLE, Great Neck, NY (US); Hongkun LI, Malvern, PA (US)

(21) Appl. No.: 18/678,452

(22) Filed: May 30, 2024

Related U.S. Application Data
(63) Continuation of application No. 18/254,726, filed on May 26, 2023.
(60) Provisional application No. 63/119,180, filed on Nov. 30, 2020.
(60) Provisional application No. 63/147,786, filed on Feb. 10, 2021.
(60) Provisional application No. 63/229,635, filed on Aug. 5, 2021.

(51) Int. Cl. H04W 24/04; H04W 4/90; H04W 48/10; H04W 48/16; H04W 48/18; H04W 60/04

(52) U.S. Cl. CPC H04W 24/04; H04W 4/90; H04W 48/10; H04W 48/16; H04W 48/18; H04W 60/04

(57) ABSTRACT

User equipment (UE) may detect a disaster condition, and the resolution thereof, based on broadcast information, RRC messaging, NAS messaging, the ability to connect to an allowable PLMN, and indications from forbidden PLMNs. In a disaster condition, a UE may perform an enhanced PLMN selection procedure wherein, for example, the UE will not consider PLMNs that are in a disaster situation if the disaster situation applies to a current location of the UE, prioritize forbidden PLMNs for disaster roaming connection. For disaster roaming connection, the UE may be configured by an otherwise forbidden PLMN with information about what services the UE can access and what type of authentication procedure the network is able to perform with UE. Upon detecting that the disaster condition is over, the UE move back to an allowable PLMN.

### CROSS-REFERENCE TO RELATED APPLICATIONS

This application claims the benefit of U.S. Prov. Pat. App. No. 63/119, 180 filed Nov. 30, 2020, U.S. Prov. Pat. App. No. 63/147,786 filed Feb. 10, 2021, and U.S. Prov. Pat. App. No. 63/229,635 filed on Aug. 5, 2021, all titled “Minimization of service interruption,” the content of which are hereby incorporated by reference herein.

### BACKGROUND

See: TS 23.122, Non-Access-Stratum (NAS) functions related to Mobile Station (MS) in idle mode; TS 24.501, Non-Access-Stratum (NAS) protocol for 5G System (5GS)-Stage 3; TS 22.261, Service requirements for the 5G system—Stage 1; TS 38.300, NR; NR and NG-RAN Overall Description—Stage 2; and TS 23.501, System architecture for the 5G System (5GS)—Stage 2.

### SUMMARY

Service interruptions may be minimized in a number of ways.

First, a UE may receive information about how to obtain connectivity in the event of a disaster, detect a disaster condition, and detect details of a disaster situation. Detection of the disaster condition may be based on received broadcast information, an RRC message, or an NAS message. The UE may determine the disaster condition when it can select no Allowable PLMN and it detects that PLMNs that are in the forbidden list are broadcasting an indication that inbound disaster roamers are being accepted.

Second, a UE may perform an enhanced PLMN selection procedure once the UE determines that one or more of its Allowable PLMNs are in a disaster situation. In the enhanced PLMN Selection procedure, the UE will not consider PLMNs that are in a disaster situation if the disaster situation applies to the UE's current location.

Third, a UE may perform a disaster PLMN selection procedure, whereby the UE determines how to prioritize forbidden PLMNs and selects a PLMN to attempt to connect for disaster roaming.

Fourth, a UE may register with a disaster PLMN (e.g., a forbidden PLMN) using an enhanced registration and authentication procedure, whereby the disaster PLMN configures the UE with information about what services the UE can access and what type of authentication procedure the network is able to perform with UE.

Fifth, a UE may detect that a disaster condition is over and move back to an allowable PLMN. Detection of the end of the disaster condition may be based on received broadcast information, an RRC message, or a NAS message, for example. The UE may determine the end of the disaster condition when it can select no allowable PLMN and it detects that allowable PLMN(s) are broadcasting an indication that the disaster situation is over, or no longer broadcasting a disaster indication.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 is a call flow of an example procedure for the minimization of service interruption Procedure.

FIG. 2 is a for chart of an example enhanced PLMN procedure and automatic mode disaster PLMN selection.

FIG. 3A illustrates an example communications system.

FIGS. 3B-D are system diagrams of example RANs and core networks.

FIG. 3E illustrates another example communications system.

FIG. 3F is a block diagram of an example apparatus or device, such as a WTRU.

FIG. 3G is a block diagram of an exemplary computing system.

FIG. 4 illustrates a system information acquisition procedure.

FIG. 5 illustrates a procedure where a UE receives information to assist with non-3GPP Access.

FIG. 6 illustrates a procedure where the network uses the Paging Channel to help the UE determine that the disaster condition is over.

### DETAILED DESCRIPTION

### Terminology

Table 1 of the Appendix describes many of the acronyms used herein. The terms “home network” and “equivalent home network” are used interchangeably herein.

Note that the procedures in this document that may be used to construct an FQDN for an N3IWF may also be applied to construct an FQDN for a TNGF or W-AGF.

The terms “Disaster Network” and “Disaster PLMN” refer to a network that provides disaster roaming services. In other words, “Disaster Network” and “Disaster PLMN” refer to networks that serve disaster roamer UEs when there is no HPLMN or EHPLMN available to the disaster roamer UE.

The following terms are used herein:

Allowable PLMN: Per TS 23.122, in the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Disaster Condition: This is the condition that a government decides when to initiate and terminate, e.g., a natural disaster. When this condition applies, users may have the opportunity to mitigate service interruptions and failures.

Disaster Inbound Roamer: A user that (a) cannot get service from the PLMN it would normally be served by, due to failure of service during a Disaster Condition, and (b) is able to register with other PLMNs.

Disaster Roaming: This is the special roaming policy that applies during a Disaster Condition.

Forbidden Area: An area where the UE is not allowed to initiate communication with the PLMN.

Service Area Restrictions define areas in which the UE may or may not initiate communication with the network. Service Area Restrictions consist of an Allowed Area which is where the UE is permitted to initiate communication with the network as allowed by the subscription. Service Area Restrictions consist of a Non-Allowed Area. In the Non-Allowed Area, the UE and the network are not allowed to initiate Service Request, or any connection requests for user plane data, control plane data, or SM signaling (except for PS Data Off status change reporting) to obtain user services that are not related to mobility (both in CM-IDLE and in CM-CONNECTED states).

DNN replacement is a procedure where the network replaces the DNN that is provided during PDU Session establishment with a network determined DNN. The network uses this procedure when it does not recognize the DNN that was provided by the UE (e.g., because the DNN is specific to the UE's home network). In the current 5G System design, the UE is not aware when DNN replacement is used.

A Public Warning System (PWS) provides a service that allows the network to distribute warning messages on behalf of a public authority. PWS enables the distribution of ETWS, CMAS (aka WEA), KPAS and EU-Alert warning messages in GSM, UMTS, E-UTRAN, and NG RAN. Messages may be distributed via broadcast.

### PLMN Selection

In order to determine to which PLMN to attempt registration, the UE performs PLMN Selection which may also be called network selection. The network selection procedure comprises two main parts, PLMN selection and access network selection. The procedures for PLMN Selection are defined in TS 23.122.

### Equivalent PLMN (EPLMN)

The UE stores a list of equivalent PLMNs. These PLMNs shall be regarded by the UE as equivalent to each other for PLMN selection and cell selection/re-selection. The UE updates the list that is associated with a PLMN at the end of each registration procedure. This is further described in TS 24.501.

As is explained in TS 23.502, when a UE registers in an SNPN, the network does not provide a list of equivalent PLMNs to the UE.

### Unified Access Control

TS 24.501 defines access control techniques for the 5G System.

When the 5G NAS layer of a UE detects that it has MO data or signaling to send, the NAS layer needs to perform the mapping of the kind of data or signaling to one or more access identities and one access category and lower layers will perform access barring checks for that request based on the determined access identities and access category. The allowable Access Identity and Access Category Values are defined in TS 22.261.

Access Categories are numbered 0-63. Numbers 32-63 are reserved for operator use. Operators may use NAS signaling to configure definitions for each of these categories in the UE. The definitions may be based on what Data Network Name (DNN) the access is associated with, what Single-Network Slice Selection Assistance Information (S-NSSAI) the access is associated with, etc.

The NG-RAN may broadcast barring control information associated with Access Categories and Access Identities as specified in TS 38.300.

In Release-17, a new Access Identity has been defined for UEs for which a disaster condition applies (Access Identity Number 3). This Access Identity is valid for PLMNs that indicate to potential Disaster Inbound Roamers that the UEs can access the PLMN.

### System Information Acquisition

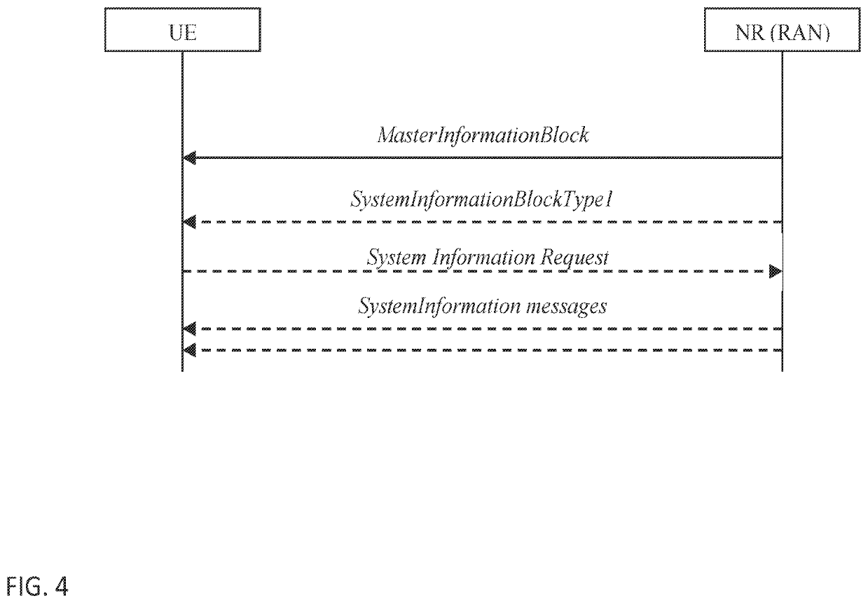

3GPP TS 38.331 describes how a UE acquires system information from a (R)AN node. FIG. 4 is copied from reference TS 38.331. The MasterInformationBlock (MIB) is always transmitted by the (R)AN node and contains information that the UE needs to obtain SIB1. The SystemInformationBlockType1 (SIB1) is transmitted with a periodicity and contains information such as scheduling information and availability information of other SIBs. The System Information Request (SI Request) is used by the UE to request that the (R)AN node broadcast a particular SIB (e.g., a SIB other than SIB1).

### Example Challenges

Disaster situations may arise that prevent a mobile network from providing services to its subscribers. Examples of disaster situations are earthquakes and fires that render parts of a mobile network, such as the base stations and core network nodes, inoperable.

Currently, the 5G System does not support procedures to mitigate service interruptions due to disaster situations. Mobile Network Operators may wish to support each other's subscribers when a disaster situation arises. For example, local regulations may require that MNOs support each other's subscribers during a disaster situation, or the MNOs may have formed an agreement to support each other's' subscribers in a disaster situation.

The fact that the MNOs support each other's subscribers in a disaster situation implies that they do not normally allow each other's subscribers to roam on their network. In fact, their subscribers might include the other network in their list of forbidden PLMNs.

At least three scenarios should be taken into account when considering how to enhance the 5G System to minimize service interruptions during disasters. First is a scenario where the RAN is not functional but at least the AUSF/UDM/UDR part of the core network is functional. The second scenario is where the RAN is functional, but at least the AUSF/UDM/UDR part of the core network is not functional. Third is a scenario where the RAN is not functional and at least the AUSF/UDM/UDR part of the core network is not functional.

### Example Use Case

In an example use case, PLMN A and PLMN B agree that their subscribers can use each other's network in the event of a disaster. The “agreement” might be based on local regulations (e.g., local law) and/or a service level agreement.

A disaster occurs and PLMN B goes down due to the disaster.

If possible, PLMN B notifies PLMN A that it is experiencing a disaster. Alternatively, the notification about a disaster can come from the government, a regulatory agency, an administrator, etc.

A UE, who is a PLMN B subscriber, will detect or be notified that PLMN B is experiencing a disaster.

PLMN A will begin to serve PLMN B's subscribers. Note that PLMN B subscribers might include PLMN A in their list of forbidden PLMNs, but such forbidden list may be overwritten or bypassed in case of a disaster.

PLMN A will only admit the PLMN B subscriber if the subscriber is in an area where the disaster applies and if the subscriber is in an area where it would normally be in coverage. Note that, when the UE connects to PLMN A, the UDM/UDR of PLMN B might not be available.

When the UE connects to PLMN A, PLMN A may provide the UE with access control policies. Later, when PLMN B resolves the disaster situation, the UE is notified, or detects, that the disaster condition is removed and will leave, or disconnect from, PLMN A.

### Detailed Problems

The scenarios described above present the following problems in the design of the 5G System.

When a disaster condition occurs, the UE, RAN, and Core Network Functions need to detect, or determine, that there is a disaster condition. Currently, the 5G System does not provide support for detecting or determining that there is a disaster condition.

The 5G system needs to be enhanced so that UE's can be made aware of which PLMNs can accept disaster inbound roamers.

The UE will select a PLMN that can serve the UE during a disaster and then register with the PLMN.

When a disaster inbound roamer UE attempts to connect to a vPLMN, there needs to be a way to authenticate the UE if the vPLMN cannot communicate with the AUSF of the hPLMN. Currently, the 5G System does not allow a UE to be authenticated if the UE's AUSF cannot be contacted.

When the disaster condition is resolved, the disaster roamer UE needs to be notified that the disaster situation no longer applies so that the UE can leave the vPLMN and return to its home network.

Note that it would not be reasonable for a UE to expect to obtain services in a disaster situation that the UE would not normally be able to obtain in the same context, e.g., same locations or time. Thus, any 5G System enhancement that provides ways to mitigate service interruptions should also allow networks to limit services obtained by a UE during a disaster situation.

Also note that, the nature of any disaster situation may cause numerous UE's to attempt to connect to another network. Any 5G System enhancement that provides ways to mitigate service interruptions should take into account any potential congestion resulting from an influx of Disaster Inbound Roamers. Also note that, the resolution of the disaster congestion may cause numerous UE's to leave a network and attempt to connect with their home network again. Any 5G System enhancement that provides ways to mitigate service interruptions should take into account any potential congestion resulting from return of Disaster Roamers.

### Example Solutions

This paper describes how the 5G System may be enhanced so that, in disaster situations, UEs can obtain service form PLMNs that normally will not serve the UE (e.g., Forbidden PLMNs).

Mobile Network Operators may be motivated by local regulations or service level agreements with other Mobile Network Operators to offer their services to subscribers who are not normally allowed to roam on their network.

In order to obtain services during a disaster, the UE generally needs to perform some combination of the following operations:

First, the UE detects a disaster condition. Second, the UE performs an enhanced PLMN Selection Procedure. Third, the UE performs a Disaster PLMN Selection procedure. Fourth, the UE registers with a Disaster PLMN (e.g., a Forbidden PLMN). Fifth, the UE detects that the Disaster Condition is over. Sixth, the UE moves back to an Allowable PLMN.

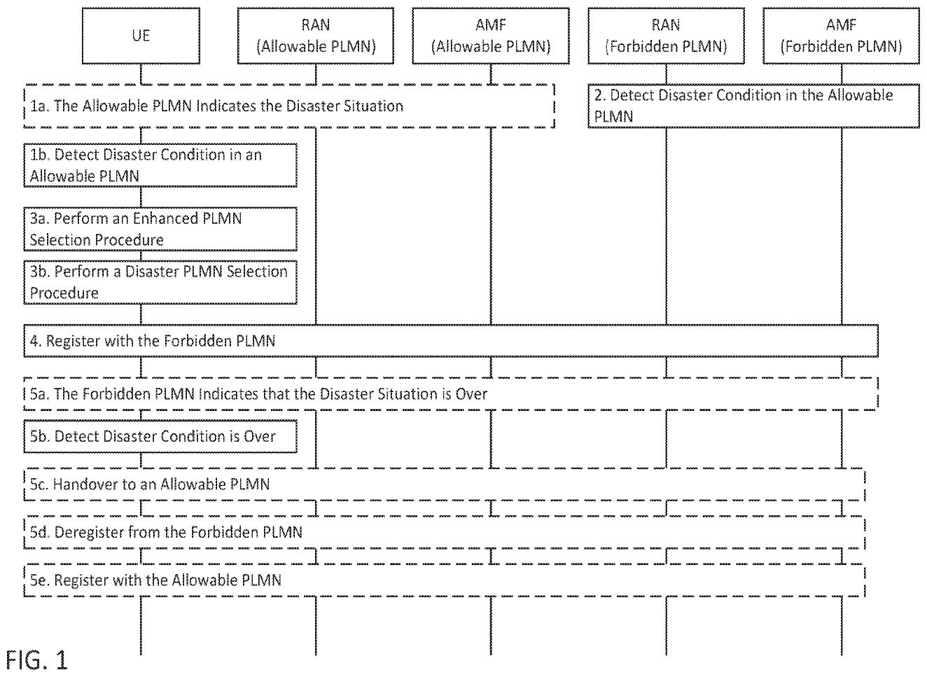

FIG. 1 illustrates an example procedure for minimizing service interruptions. In step 1a of FIG. 1, the Allowable PLMN indicates to the UE that it is in a disaster situation.

In step 1b, the UE performs PLMN Selection, but does not consider Allowable PLMN(s) that it has detected are in a disaster condition.

In step 2, a network in the UE's Forbidden PLMN list (or a PLMN that is not the UE's HPLMN, an EHPLMN, or a VPLMN that is known to the UE) detects that the Allowable PLMN from step 1 is in a disaster situation.

In step 3a, the UE performs a PLMN selection procedure that has been enhanced so that PLMNs that are in a disaster state are not considered. In an example, the UE might find no Allowable PLMNs.

In step 3b, the UE begins a Disaster PLMN Selection procedure. In this step, the UE selects a PLMN form its Forbidden PLMN list or a PLMN that is not the UE's HPLMN, an EHPLMN, or a VPLMN that is known to the UE to obtain services during the disaster.

In step 4, the UE registers with the PLMN that was selected in the previous step and obtains services. “Obtains Services” means that the UE registers with network slices, establishes PDU Sessions, sends and receives data in PDU Sessions, sends and receives SMS messages and NAS messages, etc.

In step 5a, the PLMN that the UE registered with in the previous step notifies the UE that the disaster condition is over.

In step 5b, the UE detects that the disaster is over. This detection may be based on the indication that was received from the network and described in the previous step, or it may be based on the UE reading information that is being broadcasted in the PLMN that was in a disaster situation or it may be based on the UE detecting that a PLMN stopped broadcasting an indication that it is in a disaster condition.

In step 5c, the PLMN that the UE is connected to hands the UE over to an Allowable PLMN of the UE.

In step 5d, if the handover of the previous step is not executed, the UE performs a de-registration procedure with the PLMN

In step 5e, the UE performs a registration procedure with the Allowable PLMN

Throughout this document we describe how information may be received by the UE in a broadcast (e.g., by reception of a SIB). It will be appreciated that disaster information may also be received in a PWS message. Furthermore, if the information is encoded in a SIB other than SIB1, then it will be understood that the UE will first determine to send the network a request to broadcast the SIB with the relevant disaster information.

Throughout this document we describe how information can be sent to and from the UE in NAS messages. It will be appreciated that SMS is a type of NAS message because NAS can carry SMS messages.

### Detecting and Determining Disaster Conditions at the UE

As illustrated in step 1 of FIG. 1, the UE may receive Disaster Information from a PLMN. The Disaster Information may indicate that the PLMN is in a disaster situation. The Disaster Information may be information that is broadcast by the PLMN in the SIB or MIB.

In cases where the UE is already connected to the network and the network can at least send control plane messages to the UE, the network can send a control plane message to the UE with the Disaster Information. The control plane message may be an RRC message from a RAN node or an NAS message from an AMF. In addition, the network may send a list of possible PLMNs that the UE can switch to during the disaster condition. Each PLMN in the list may be associated with a precedence number to imply the preference.

If the control plane notification message is sent in NAS message, the notification may be sent to the UE in a De-Registration Request, in response to a Registration Request (e.g., an initial or mobility registration), in a UE Configuration Update Command, or in response to a Service Request.

Prior to receiving disaster information from the network in a NAS or RRC message, the UE may first indicate to the network that it supports receiving disaster information. Such an indication may be required so that the network recognizes that the UE is able to understand the information and is not an earlier release UE that is incapable of understanding the information. In response to the UE providing such an indication, the network may provide a list of Forbidden PLMNs that the UE may try to connect to in case of disaster conditions. The list may contain a version number in which the network maintains and references to during disaster situations. Different lists may be maintained in which the order of the PLMNs is based on the UE identity or, the list may contain different numbers of Forbidden PLMNs to disperse where roaming UEs connect to during disaster conditions.

The UE may alternatively, or additionally, receive an indication from a second PLMN that a first PLMN is in a disaster situation. For example, a PLMN may broadcast an SIB message Disaster Information that indicates that another PLMN is in a disaster situation. This broadcast may additionally indicate if the PLMN is willing to accept inbound disaster roamers from the first PLMN.

The UE may alternatively, or additionally, determine that there is a disaster situation. For example, the UE may detect that it can select no suitable PLMN other than forbidden PLMNs. This may cause the UE to begin a disaster detection procedure. In the disaster detection procedure, the UE will check the SIB and/or MIB information that is broadcast by forbidden PLMNs to determine if they are broadcasting an indication that they are accepting disaster inbound roamers or if any of the forbidden PLMNs is broadcasting an indication that the UE's home network is in a disaster situation. If any forbidden PLMN is broadcasting an indication that they are accepting disaster inbound roamers or is broadcasting an indication that the UE's home network is in a disaster situation, then the UE will determine that there is a disaster condition.

The UE may determine that there is a disaster situation based on input from a user. For example, the TE part of the UE may present a GUI to the user that allows the user to provide Disaster Information to the UE. The TE may then use an AT Command to provide the Disaster Information to the MT. The information that is received in the AT command may be used by the MT part of the UE to immediately enter disaster mode and begin attempting to determine what forbidden PLMN (e.g., disaster PLMN) to connect to or at least spend less time searching for and attempting to connect to the HPLMN and E-HPLMNs. Note that the Disaster Information that is entered in the GUI and provided to the MT may include the identities of PLMN(s) that the UE may connect to during the disaster.

The Disaster Information that is received by the UE may be a single bit indication that indicates that the PLMN is in a disaster situation at least in the area where the UE received the Disaster Information. The Disaster Information may additionally include one or more of the following five items of information, for example.

First, location information where the disaster applies. The location information may be conveyed as geographical coordinates, cell id(s), or tracking area(s).

Second, time information indicating a minimum amount of time that the UE should wait before checking if disaster has been resolved and returning the PLMN that is impacted by the disaster.

Third, the identities of PLMN(s) that may be able to serve the UE in the event of a disaster. This information may additionally include information to help the UE determine in what order it should try to connect to the PLMN(s). The information may include information about what priority level UEs the PLMN is willing to serve in the event of a disaster. Of course, once a UE connects to one to the PLMNs, it will not attempt to connect to the other PLMNs.

Fourth, back-off information that helps the UE determine how much time it should wait before attempting to connect to PLMN that is available. This information may be used to assign a value to a timer in the UE and the UE may not attempt to connect to the PLMN until the timer expires. The time that is assigned to the timer may be based on the back-off information and adjusted based on internal UE logic in order to avoid situations where many UE attempt to simultaneously connect to the same PLMN.

Fifth, the Disaster Level, or Disaster Type. This field indicates how much of the network is disabled (e.g., the RAN, Core, IMS domain, or combinations of the three). Alternatively, this field may indicate particular services that are disabled (e.g., voice, SMS, data, or combinations of the three). If the disaster level indicates that the RAN part of the network is disabled, it may further indicate which RAT types are disabled. For example, the disaster level may indicate that only the NR part of the RAN is disabled, only the non-3GPP part of the RAN is disable, or both the NR and non-3GPP parts of the RAN are disabled. Additionally, the Disaster Level information may indicate that certain parts of the network are not disabled. For example, the Disaster Level Information may indicate that the NR part of the RAN, non-3GPP part of the RAN, or Core Network are functional.

Sixth, an indication of whether the broadcasting network is experiencing a disaster.

Seventh, the identities of PLMN(s) whose roamers the network is willing to accept in the event of a disaster.

Eighth, a UE disaster priority which will be used when selecting a Forbidden PLMN during a disaster.

Some of the Disaster Information described above may be sent to the UE before any disaster condition occurs or any disaster condition is imminent. For example, before any disaster condition occurs or any disaster condition is imminent, the network may send the UE the identities of PLMN(s) that may be able to service the UE in the event of a disaster. The information may be sent in a NAS or RRC message. Later, when the UE detects that the network is in a disaster situation (e.g., via the presence or absence of broadcast information) the information can be used by the UE to determine what network to connect to as a disaster roamer. As described above, the information that is provided to the UE may additionally include information to help the UE determine in what order it should try to connect to the PLMN(s).

The UE sends the network the Disaster Information that is provisioned in the UE so that the network can check if the information is up to date. For example, the UE may provide the information to the network in a mobility registration update or periodically or in response to a UE Configuration Update. If the network (e.g., the AMF) determines that the information is not up to date, then the network may send updated disaster information to the UE. Instead of sending all the disaster information to the network, the UE may send an identifier that is associated with the disaster information. The network may then resolve the identifier to the actual disaster information (e.g., PLMN IDs) and determine if the information is up to date. The identifier that is associated with the disaster information may have been received by the UE from the network with the Disaster Information.

A UE may obtain Disaster Information from another UE via PC5 signaling. Specifically, the UE could broadcast the disaster information via PC5 based on the configuration provided by network or pre-configured by operator.

A UE may also be notified on the non-3GPP leg of an MA-PDU session that the 3GPP access is in a disaster situation. As a result, logic in the UE may prevent the UE from repeatedly trying to connect to the 3GPP access. Depending on UE policy, the UE may then attempt to connect to Forbidden PLMNs.

When a first UE provides a second UE a list of PLMNs that can be considered in the event of a disaster, the first UE may randomize the order of the PLMNs in the list. The second UE may then prioritize connecting to PLMN(s) that appear earlier in the list. This randomization would provide the benefit of decreasing the likelihood that a relatively high percentage of UE's will try to connect to same network(s) during the disaster station. The first UE may provide the information over the PC5 link to the second UE when the second UE is out of coverage or lose connection to the network. Network may authorize the first UE to provide such information to other UEs. Network may indicate to UE a specific list of PLMNs provisioned to a set of UEs in certain location, cells or tracking area. Moreover, network may indicate to the UE in which conditions or events the UE can provide the PLMN list. The authorization and configuration can be done by network through registration, registration update, UE configuration update or service request procedures.

### Anticipating Disaster Conditions in the UE

The network may detect that the UE is close to a location where the network is in a disaster condition. This may trigger the network to send a NAS or an RRC message to the UE. The message may include information about the disaster condition such as: an indication of the disaster condition and location; PLMN IDs that maybe used during the disaster situation and in the location of the disaster; PLMN IDs that may not be used during the disaster situation and in the location of the disaster; a set of cell priorities that include cells of the PLMNs that cannot serve the UE during the disaster; a set of cell priorities that include cells of the PLMNs that can serve the UE during the disaster; and/or a back-off timer value in case the UE is not able to initially connect to the Forbidden PLMN. The Back-off timer may indicate how long the UE needs to wait before attempting to access the same PLMN.

Reception of the message may cause the UE to do a number of things. First, the UE may purge its Forbidden PLMN list or remove specific PLMNs (e.g., the PLMNs that were indicated in the received message) from its forbidden list. Alternatively, the UE may have been previously configured with PLMN IDs that should immediately be purged from the UE's forbidden list in the event of a disaster. The UE may choose to not purge its Forbidden PLMN until it enters the indicated location.

Next, when the UE enters the indicated location, the UE may select one of the indicated cells in a PLMN that can serve the UE. Alternatively, after sending the disaster notification to the UE, the network may initiate a handover procedure with the UE where the UE is handed over to a cell in a PLMN that can serve the UE during the disaster.

If the UE is unable to initially connect to the Forbidden PLMN, the UE initiates the back-off timer before trying to reconnect again.

Alternatively, the network may send the information about the disaster condition in a cell broadcast message or in a SIB.

### Verifying a Disaster Condition

When the UE receives information in a broadcast from a first network that indicates that a second network is experiencing a disaster condition, the UE needs a way to verify that the information is accurate. For example, it may be the case that the information was received from a malicious/fake network that was broadcasting inaccurate information.

The UE may verify that the second network is experiencing a disaster condition by sending a third network a NAS or RRC message to the network to query, or check, about the disaster situation. Examples of a NAS or RRC message that queries, or checks, about the disaster situation are described later in this document. The third network may be a network that the UE is already registered to when it receives a broadcast from the first network that the second network is experiencing a disaster condition.

The UE may alternatively verify that the second network is experiencing a disaster condition by attempting to register with the second network. The registration request may include an indication in the RRC and/or NAS parts of the message that the UE is checking if the network is in a disaster situation. If the network is not in a disaster situation, the network may respond by accepting the registration request or, if the network is in a disaster situation, the network may reject the registration attempt with an RRC or NAS cause code that indicates, or confirms, that the network is in a disaster situation.

The UE may also determine that the second network is in a disaster condition if during cell selection, the UE does not find a cell belonging to the PLMN. Alternatively, a UE may try to verify the disaster condition via the non-3GPP access leg of an MA-PDU session.

### Checking for a Disaster Condition

When the UE is not able to register with an Allowable PLMN, the UE may trigger a procedure to check if a disaster situation is underway. The checking procedure may involve requesting that a network from the UE's forbidden list broadcast particular SIB information (e.g., Disaster Information), receiving information that a network from the UE's Allowable PLMN list is experiencing congestion, then attempting to establish an RRC Connection with a PLMN from the UE's forbidden list.

### Pre-Provisioning for Disaster Conditions

Network operators may pre-provision the UE with information related to all disaster condition handling. The following options may be made part of this pre-provisioning:

First, a GUI allowing the user to be informed of the disaster functionality available based on their subscription.

Second, a GUI allowing the user to make service selections for functionality to be prioritized or de-prioritized during disaster conditions, corresponding to choices of subscription levels.

Third, offloading rules (e.g., URSP and ATSSs rules) for PDU sessions. For example, the rules may dictate that all PDU Sessions are to be established over Wi-Fi in disaster situations.

Fourth, pre-provisioned AF/AS information for disaster-handling servers associated with the PLMN operator, along with rules for contacting the AS. The AS in turn may be used to receive OTT notification for disaster conditions, receive further rule updates for disaster handing, etc. The UE's connection with the AS would be established via an IP connection, but the information exchanged with the AS may be used for disaster handling in the cellular network.

Fifth, pre-provisioned applications, along with rules for their functioning during the disaster situation. For example, specific apps may be provided for OTA messaging while the SMS infrastructure is down, which may be used seamlessly during the disaster if off-band connectivity (e.g., WiFi) is established. This would allow users to send and receive messages using the same app or contact information as for SMS, and not have to move to alternative OTA messaging solutions, although the messages are not delivered via the Control plane.

Sixth, a UE disaster priority.

### Detecting and Determining Disaster Conditions in the Network

As illustrated in step 2 of FIG. 1, network nodes such as RAN Nodes (e.g., base stations and cells) and Network Functions (e.g., the AMF) may be notified via OAM procedures that there is a disaster situation. For example, the OAM system may receive a notification about the disaster from the PLMN that is experiencing the disaster, an administrator, or a government agency. The OAM system may then forward the information to the RAN Nodes and/or Network Nodes. Alternatively, the NWDAF may predict based on its analysis that a disaster is occurring and provide the prediction to the RAN Nodes and/or other Network Nodes.

The notification message may apply to the network node or apply to other network nodes.

The notification message may apply to the PLMN or it may apply to other PLMNs.

Reception of the notification message by a first RAN Node may cause the first RAN node to broadcast the Disaster Information that is described above. Additionally, the first RAN node may distribute the Disaster Information to other RAN nodes via an Xn interface. The other RAN nodes may broadcast the information and further indicate that the information applies first RAN node.

Reception of the notification message by a RAN Node may cause the RAN node to send an RRC message to UEs and the RRC message may include the Disaster Information that is described above.

Reception of the notification message by a Network Function such as the AMF may cause the AMF to send a notification message to RAN nodes where the disaster applies. The message maybe sent via the N2 interface that the UE maintains with each RAN node. When the RAN node receives the Disaster Information, the RAN node may begin to broadcast and/or send control plane messages as described above.

Reception of the notification message by a Network Function such as the AMF may cause the AMF to send a NAS notification messages (e.g., UE Configuration Update) to UE(s). The NAS Notification may include the Disaster Information that is described above. The AMF may determine to which UE(s) to send notification messages based on the location of the UE(s) and the location information that was received in the OAM notification. For example, if the OAM notification indicates to the AMF that there is a disaster in the northern section of a city, the AMF may use this information to determine to send NAS Notifications to all UE(s) that are in the northern section of the city or all UE(s) that are close to the northern section of the city.

Alternatively, the network nodes such as RAN Nodes (e.g., base stations and cells) and Network Functions (e.g., the AMF) may be notified by the NEF. For example, the NEF may receive a notification about the disaster from an AF in the PLMN that is experiencing the disaster, an administrator AF, or a government agency AF. The NEF may then forward the information to the RAN Nodes and/or Network Nodes.

Alternatively, the 5G Multicast Broadcast system maybe be used to distribute the information. A special TMGI may be reserved that UE's can listen to for Disaster Information.

Alternatively, the operator may set up the special AF that is responsible for notifying UE about the disaster, so that UE will receive the notification from the special AF via the user plane path.

### PLMN Selection by the UE During a Disaster

Automatic Mode PLMN Selection is defined in reference TS 23.122. As illustrated in step 3 of FIG. 1, here, it is proposed that the Automatic Mode PLMN Selection be enhanced so that it can trigger a Disaster PLMN Selection procedure. The Disaster PLMN Selection procedure may have an automatic mode and a manual mode.

### Automatic Mode Disaster PLMN Selection

If a UE determines that a disaster condition applies to a network that it is registered with, then the UE will de-register from the network and begin normal Automatic PLMN selection. However, the normal PLMN Selection procedure should be adjusted so that the UE does not consider Allowable PLMNs that are in a disaster situation. How the UE determines that a disaster situation applies to a PLMN is described above.

When in automatic PLMN selection mode, the UE may determine that there are no Allowable PLMNs that are not in disaster mode. Once the UE makes this determination, it will trigger an Automatic Disaster PLMN Selection procedure.

In the Automatic Disaster PLMN Selection procedure, the UE will begin to attempt to connect to PLMNs that are the UE's “forbidden list.” Alternatively, UE may have a separate list of PLMNs that are only accessible for the disaster mode.

The UE will first prioritize PLMNs that it has been explicitly notified will accept disaster roamers. Explicit notification includes receiving Disaster Information in a NAS or RRC message as described above. Alternatively, an explicit notification may include receiving SIM configuration information that indicates PLMN(s) that can serve the UE when a disaster situation applies. The SIM configuration information may also include location information such that the UE knows whether the PLMN(s) can, or cannot, serve the UE during disasters in certain locations. Alternatively, an explicit notification may be included in a NAS rejection message with a cause code that causes the PLMN to be added to the UE's forbidden list. For example, the indication and cause code combination may tell the UE that the PLMN should be added to the UE's forbidden list, but the UE may prioritize the PLMN when it performs the Disaster PLMN Selection procedure. The NAS rejection message may further include information that tells the UE locations where the PLMN can, or cannot, serve the UE in the event of a disaster.

If the UE is not able to successfully register with a PLMN from the “forbidden list” for which the UE previously received indication that the PLMN will accept disaster roamers, then the UE will add this PLMN to a “disaster forbidden list” and keep this PLMN in the “disaster forbidden list” for a configurable amount of time. Once the UE has exhausted PLMN(s) from the “forbidden list” for which the UE previously received indication that the PLMN will accept disaster roamers, the UE will begin to attempt to Register with PLMNs that are broadcasting Disaster Information. How PLMNs broadcast Disaster Information is described above. If the UE is not able to Register with any PLMN that is broadcasting Disaster Information, the UE will add this PLMN to a “disaster forbidden list” and keep this PLMN in the “disaster forbidden list” for a configurable amount of time. Once the UE has exhausted PLMN(s) from the “forbidden list” that are broadcasting Disaster Information, the UE may attempt to register with other PLMNs from its forbidden list.

When selecting a Disaster PLMN, the UE may consider its UE disaster priority and any information that it received about each PLMN's willing to serve UEs with different UE disaster priorities.

As described above, the UE may find that it is not able to successfully register with a PLMN. This may happen because the network is experiencing a congestion situation due to a large influx of disaster roamers. Thus, when a UE attempts to establish an RRC connection or Register with a PLMN from the “forbidden list,” the PLMN may reject the RRC connection or Registration with a cause code that indicates that the network is congested and not accepting disaster roamers. Having a cause code that is specific for disaster roamers may be advantageous for Multi-SIM UEs so that the UE is aware that the network is considered to be congested for disaster roamers but not for roamers that consider the PLMN to be an EHPLMN or HPLMN. For example, if the PLMN is in the forbidden list of one SIM but is considered an EHPLMN for the other SIM. The Multi-SIM UE may determine to maintain registration with the SIM with an EHPLMN and not try to register the SIM whose network is in a disaster condition. In addition, Multi-SIM UEs may temporarily disable trying to register to a “forbidden PLMN” for one SIM if the UE was able to successfully register to a “forbidden PLMN” with another SIM in the UE.

The UE may also have been configured with information that informs the UE that Disaster Roaming (e.g., Disaster PLMN Selection) is not allowed in certain geographical areas. When the UE is configured with such information, the UE will not begin the Disaster PLMN Selection procedure.

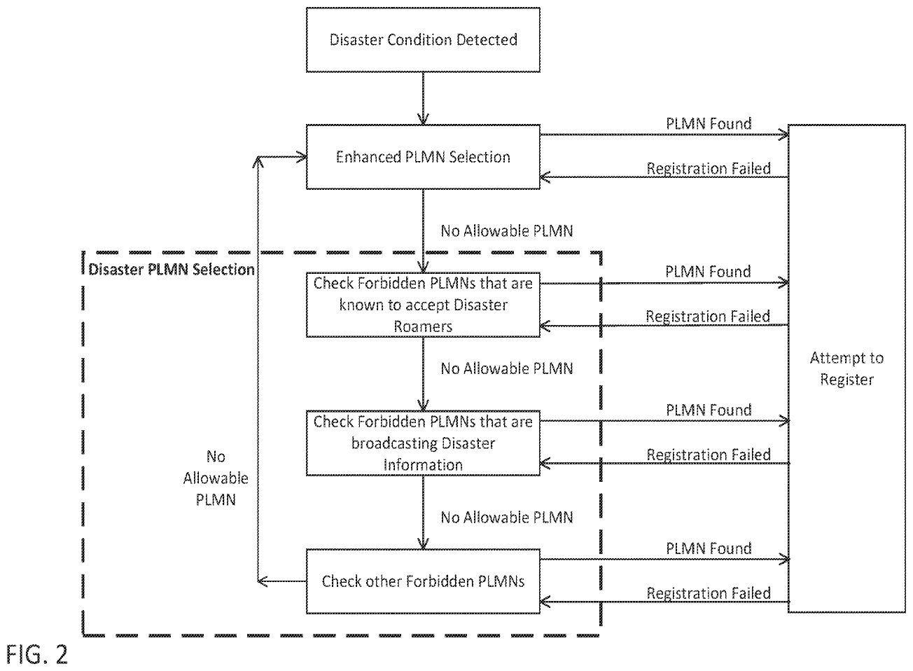

The enhanced PLMN Procedure and its interaction with the Automatic Mode Disaster PLMN Selection is shown in FIG. 2.

Alternatively, the UE may consider PNI-SNPN's for PLMN selection before PLMNs from the forbidden list are considered. When the UE detects that it can connect to no Allowable PLMNs, the UE may use a GUI to indicate to the user that it can connect to no Allowable PLMNs. The GUI may further indicate whether a disaster condition was detected. The GUI may allow the user to indicate if the UE should attempt to connect to PNI-NPN's and/or forbidden PLMNs. The UE may have been pre-configured with the identities of PNI-NPNs that can serve the UE in an event of a disaster. An PNI-NPN or a base station of any PLMN may broadcast a Group ID that has been reserved for select disaster roamers. Selected UEs may be pre-configured with the Group ID and attempt to register with any network that the UE detects is broadcasting the disaster Group ID.

### Considering Access Class and Access Identities in PLMN Selection

The disaster information that is broadcast by a PLMN may be a negative indication. In other words, the UE may assume that a PLMN does support disaster roamers unless the network is broadcasting an indication that it does not support disaster roamers. The indication that the network does not support disaster roamers may be an indication that UEs for which a disaster condition applies (Access Identity Number 3) are barred from the network. When a PLMN is broadcasting this barring information, the UE will not consider it for Disaster PLMN selection but may consider the PLMN if the PLMN is already an Allowed PLMN.

### Manual Mode Disaster PLMN Selection

It is proposed that if a UE determines that a disaster condition applies to a network that it is registered with, then the UE will de-register from the network and begin normal Automatic PLMN selection. However, the normal PLMN Selection procedure should be adjusted so that the UE does not consider Allowable PLMNs that are in a disaster situation. How the UE determines that a disaster situation applies to a PLMN is described above.

When in automatic PLMN selection mode, the UE may determine that there all the Allowable PLMNs are in disaster mode. Once the UE makes this determination, it may begin a Manual Disaster PLMN Selection procedure.

In the Manual Disaster PLMN Selection procedure, the TE part of the UE will use a GUI to display the identities of PLMNs that are in the UE's “forbidden list.” The MT may use an AT command to send the list to the TE. The GUI may indicate to the user that there is a disaster situation, and the GUI may list the PLMNs that the UE is able to try to connect to in the event of disaster. The GUI may indicate to the UE which PLMNs are mostly like to serve the UE. For example, the list may indicate that PLMNs for which the UE was explicitly notified would accept disaster roamers are mostly like to accept the UE. The list may indicate that PLMNs which are broadcasting Disaster Information are next most likely to accept the UE. The list may indicate that other networks from the forbidden list are least likely to accept the UE. The likelihood of acceptance may also depend on the current location of the UE.

The GUI may allow the user to select a PLMN from list. Once a PLMN is selected by the user, the UE will attempt to connect to the PLMN in disaster mode.

The UE may also have been configured with information that informs the UE that Disaster Roaming (e.g., Disaster PLMN Selection) is not allowed in certain geographical areas. When the UE is configured with such information, the MT part of the UE may send this information to the TE so that it can be displayed in a GUI.

The MT may use AT Commands to send the following information to the TE.

First, an indication that there is a disaster condition. Furthermore, the indication may be part of an error response from the MT, or the TE may determine that there is a disaster condition based on a series of error responses from the MT.

Second, an indication that the disaster condition applies to all Allowable PLMNs.

Third, the identities of the PLMNs that the disaster condition applies to.

Fourth, the geographical area the disaster condition applies.

Fifth, a list of Forbidden PLMNs and an indication that these PLMNs might be able to serve the UE during the disaster situation. The indication may indicate to the UE that the UE should randomize the selection the Forbidden PLMNs to prevent overload situations where a large number of UEs attempts to connect to the same Forbidden PLMN.

Sixth, for each Forbidden PLMN, an indication of whether or not the MT already received an indication that that the Forbidden PLMN is able to serve UEs during the disaster condition.

The TE may display this information to the user and the user may use this information to determine which Forbidden PLMN the UE should attempt to connect to. Another AT command may be used by the TE to indicate to the ME which Forbidden PLMN the UE should attempt to connect to.

As an alternative, the TE may select from the list of Forbidden PLMNs automatically based on the order provided or in a randomized fashion if indicated and as described hereinafter

### Distributing PLMN Roamers more Evenly

When a disaster condition applies, it is desirable to evenly distribute the subscribers of the PLMN with the disaster condition among the PLMNs without the disaster condition, so the networks share the load as evenly as possible.

FIG. 2 shows a procedure that a UE may use to select a PLMN to serve the UE during a disaster. It is proposed that, each time the UE forms a list of PLMNs to choose from, the UE uses a rule to prioritize the PLMNs. The rule may be designed such that all UEs that are subject to the disaster condition are not likely to prioritize PLMNs in the same way. Such an approach will decrease the likelihood that a high percentage of the disaster roaming UEs will all attempt to select the same PLMN. For example, the rule maybe be based on an identity of the UE. For example, the rule may be based on several (e.g., 5) LSBs of the UE's IMSI, 5G-GUTI, etc. Furthermore, the list of PLMNs may be ordered in a standardized manner (e.g., based on the several (e.g., 5) LSBs of the PLMN ID) and the UE may determine the order in which it attempts to register with each PLMN based on the several (e.g., 5) LSBs of an identity of the UE. In a different example, the PLMN may be listed in an order (e.g., 1-4) and the UE may determine which PLMN it attempts to Register with first by performing a modulo operation. The modulo operation may be at least a portion of the UE's identity (e.g., a select number of bits from the UE's IMSI) modulo the number of detected Forbidden PLMNs (e.g., 4 detected Forbidden PLMNs). In another example, the detected PLMNs may be listed in priority order (e.g., 1-4) and the UE may determine its own priority by generating a random number (e.g., 1, 2, 3, or 4).

The selection rule may be implemented as the procedure of FIG. 2 is executed and the list of PLMNs may be a list of Forbidden PLMNs, a list of Forbidden PLMNs that are known to accept Disaster Roamers, a list of Forbidden PLMNs that are Broadcasting Disaster Information, or a list of Forbidden PLMNs that are neither known to accept Disaster Roamers or Broadcasting Disaster Information. The list of PLMNs may have been received as part of the Disaster Information that was previously described. If the list of PLMNs was sent to the UE in a control plane message and not via broadcast, then the network may have ordered the PLMNs in the list differently for each UE that it sent a list and indicated to the UE that the list has been randomized so that the UE is aware that it can prioritize the PLMNs in the order that they were received and there is no need for the UE to execute its own prioritization algorithm.

### UE RAT Selection

The UEs RAT Selection procedure may be modified when it detects a disaster condition such that the UE will still attempt to use non-3GPP access to initially register with the Disaster PLMN. In other words, the UE may behave as if the NR radio is restricted (e.g., not allowed) when a disaster situation is detected. If the UE successfully uses the non-3GPP RAT to register with the Disaster PLMN, then the UE may consider the NR radio to be restricted until the Disaster Network signals to the UE that the NR radio is no longer restricted. If the UE does not successfully use the non-3GPP RAT to register with the Disaster PLMN, then the UE may consider the NR radio to be no longer be restricted and attempt to use the NR radio to register with the Disaster PLMN.

### UE Registration During a Disaster

As described above, the UE may receive Disaster Information that indicates the Disaster Level. The UE may use the Disaster Level information to determine if it is possible to register with the network in the current location. For example, the Disaster Level information may indicate that the network is in a disaster situation in the UE's current location (geographical coordinates, cell id(s), or tracking area(s)). However, the Disaster Level Information may also indicate that only NG RAT part of the RAN is in a disaster situation or that the core network part of the network is functional. When the UE detects that the core network part of the network is operational, the UE may be configured to attempt to use non-3GPP access to register with EHPLMN (i.e., the PLMN that is in a disaster situation) before the UE attempts to become a disaster roamer. In other words, the UE may be configured to determine that registration with an EHPLMN via non-3GPP access is not possible before it attempts to become a disaster roamer.

Attempting to Register with the EHPLMN may require that the UE construct an N3IWF Tracking/Location Area Identifier FQDN. However, it may be that the UE cannot determine what tracking area of the HPLMN since the RAN node that would normally broadcast a 5GS TAI is disabled (e.g., in a disaster situation). When the UE determines that the RAN part of the network is in a disaster situation, the UE may execute a modified N3IWF Tracking/Location Area Identifier FQDN construction procedure. The modified procedure may involve the UE using the 5GS TAI of the EHPLMN that the UE most recently successfully detected to construct the N3IWF Tracking/Location Area Identifier FQDN.

As illustrated in step 4 of FIG. 1, when the UE sends a Registration Request to the network, the UE may include a disaster indication in both the RRC and NAS parts of the message. The indication may be included in the RRC part of the message so that the RAN node can consider the disaster indication during AMF selection. In addition, UE may use a pre-configured S-NSSAI to indicate that it wants to register for disaster mode. The special S-NSSAI will be reserved by operator for the disaster mode usage.

The disaster indication may be an information element in the Registration Request, or the indication may be provided to the network by defining a new registration type.

When the UE registers with the network, the UE may provide its UE disaster priority so that the network can determine its willingness to serve the UE. For example, if the UE indicates that it is low priority, the network may reject the registration and provide a cause code indicating the priority levels that the network is willing to serve.

During the Registration procedure, the AUSF may indicate to the UE that the AUSF does not belong to the UE's HPLMN, but belongs to the PLMN that the UE is attempting to register with. The AUSF will send this indication to the UE in situations where the PLMN cannot communicate with the AUSF of the HPLMN (e.g., because of the disaster).

This indication that the home network AUSF is not reachable, may trigger a different authentication procedure where the UE uses a Disaster Identifier to authenticate. This alternative identifier may have been previously stored in the UE's SIM. The disaster network may have previously been configured with subscription information for the UE that is associated with the disaster identifier.

During the registration procedure, the network may configure the UE with service area restrictions and/or Forbidden Areas and indicate to the UE that the service area restrictions and/or Forbidden Area are configured due to the fact that the UE is not normally able to obtain service in the Forbidden Area or non-allowed area.

When the network indicates the areas where the UE can obtain service from the network, the area information can be expressed in different formats such as tracking areas or cell identities.

During the registration procedure with a new PLMN, the network may indicate to the UE that the UE's home network and subscription information is not available, thus the services that can be obtained by the UE are limited. The Registration Accept procedure may be used to send this indication to the UE and further indicate to the UE which services it can access. In this situation, the network may provide the UE with a Disaster Configured NSSAI, which may be treated like the Configured NSSAI during the disaster situation. Alternatively, the network may provide the UE with a Disaster Mapping of Configured NSSAI that indicate to the UE that all slices from the UE's configured NSSAI should be mapped to a single slice (e.g., an eMBB slice) or that all slices from the UE's configured NSSAI of a certain type should be mapped to a single slice.

When the network provides the UE with a Disaster Configured NSSAI or a Disaster Mapping of Configured NSSAI, the network may also provide the UE with a PDU Session Count Limit for each slice in the Disaster Configured NSSAI or Disaster Mapping of Configured NSSAI. The PDU Session Count Limit may be a disaster limit that limits how many PDU Session(s) the UE may establish in each slice when connected to a network as a disaster roamer. Additionally, the PDU Session Count Limit may be set for the slice as a PDU session quota for maximum number of PDU sessions exclusively for Disaster Configured NSSAI or a Disaster Mapping of Configured NSSAI, which may be updated based on disaster situation and UE density. Alternatively, the limit for each S-NSSAI (e.g., slice) in the Disaster Configured NSSAI or Disaster Mapping of Configured NSSAI may be provided to the UE when the UE executes a PDU Session Establishment or PDU Session Modification procedure in the slice.

The PDU Session Count Limit may be considered by the UE when evaluating URSP rules. For example, when the UE evaluates a route (e.g., RSD) in a URSP rule to determine whether it should be associated with an application, the UE may consider the route invalid if a PDU Session that does not match the RSD has already been established in the slice that is indicated in the RSD. In other words, the URSP and RSD may indicate that it is preferred that the UE establish a new PDU Session, however, the UE may choose to instead use an existing PDU Session for the application traffic because the UE has already attained the PDU Session Count Limit. The existing PDU Session may be described by a lower priority RSD.

The UE may also be provided back-off timers that can be used by the network to control the frequency of PDU Session Establishment. For example, the network can indicate that the UE may attempt to establish a new PDU Session no sooner than 5 minutes have a previous PDU Session was established.

The Registration Accept message may further indicate to the UE that the network will not recognize any DNN's that are received by the UE and that DNN Replacement will be used. Alternatively, the UE may always assume that DNN replacement will be used in disaster situations or the network may indicate to the UE that DNN replacement was used in a PDU Session Establishment Accept message.

The Registration Accept message may further indicate to the UE that the services available to the UE are limited to voice (or some other list of services), max # PDU session, or only certain QFI values.

The Registration Accept message may further indicate how long the UE should wait before checking if the disaster situation has been resolved or how often the UE is required to check if the disaster situation has been resolved.

During normal (non-disaster) operation, when the UE is configured with Forbidden Area information by any Allowable PLMN, the UE may store this information. When the UE detects that it is in an area that is forbidden during normal operation, it should consider this area forbidden by all PLMNs during disaster roaming.

### Non-3GPP Access Considerations During a Disaster Registration

The network may determine that the UE's Registration Request was sent from a location where the non-3GPP access to the UE's HPLMN or an EHPLMN of the UE may be available. In this situation, the network may send a Registration Reject message to the UE, the Registration Reject message may provide the UE a rejection cause code that indicates that the UE's registration is being rejected because non-3GPP access to the UE's HPLMN or an EHPLMN of the UE may be available in the UE's current location. The AMF may determine that the UE is non-3GPP capable by checking the UE's “UE Radio Capability ID” or based on a new non-3GPP support indication that is provided by the UE to the AMF in the Registration Request in the 5GMM Capability Information Element. The network may determine to not reject the UE if the UE is not non-3GPP capable, even if the non-3GPP access of the HPLMN or EHPLMN is available in the UE's current location.

The Registration Reject message may further include 5GS TAIs of the UE's HPLMN and EHPLMNs that can be used by the UE to construct an N3IWF Tracking/Location Area Identifier FQDN that may be reachable in the UE's current location. Including the 5GS TAIs in the Registration Reject message is advantageous because the UE's HPLMN and EHPLMNs may be in a disaster state and not broadcasting any 5GS TAI. The Registration Reject message may further include Disaster Level information. Including Disaster Level information in the Registration Reject message may be beneficial because the UEs attempt to perform disaster roaming in a location where the UE should be able to obtain services from the UE's HPLMN or EHPLM may be an indication that the UE is configured with wrong or out of date Disaster Level information.

Alternatively, the Registration Reject message may further include one or more N3IWF Tracking/Location Area Identifier FQDNs that may be reachable in the UE's current location.

Alternatively, the network may send a Registration Accept message to the UE and indicate to the UE that a UE Configuration Update message with updated disaster information is pending. The Registration Accept may include no Allowed NSSAI in order to indicate to the UE that it cannot obtain services from any network slice. The network may subsequently send a UE Configuration Update message to the UE that includes updated Disaster Level information and includes 5GS TAIs of the UE's HPLMN and EHPLMNs that can be used by the UE to construct an N3IWF Tracking/Location Area Identifier FQDN that may be reachable in the UE's current location. Reception of the UE Configuration Update message by the UE may cause the UE or Network to initiate the Deregistration procedure. Alternatively, the network may initiate a deregistration procedure and include the updated Disaster information in the Deregistration Request that is sent to the UE.

The Registration Accept message may also include a TMGI for a MBMS group which the UE may listed to for disaster-related communications (e.g., disaster start and stop notifications).

Reception of a Registration Reject message that was sent for disaster roaming and reception of the 5GS TAIs of the UE's HPLMN and EHPLMNs that can be used by the UE to construct an N3IWF Tracking/Location Area Identifier FQDN, may cause the UE to construct one or more N3IWF FQDNs with the received information, attempt to use the constructed FQDN to discover and connect to an N3IWF, select an N3IWF, and send a Registration Request to the UE's HPLMN or EHPLMN.

If the UE's non-3GPP RAT is disabled, if the UE does not have a non-3GPP RAT, or if the UE failed to discover, select, or contact an N3IWF, the UE may indicate to the network that it is a disaster roamer and it is not able to obtain access to the HPLMN or an EHPLM via non-3GPP access, that the UE does not have a 3GPP RAT, or that the UE's 3GPP RAT is disabled. Providing this indication to the network may avoid the network determining that the UE can access the HPLMN or EHPLM via non-3GPP access in the UE's current location.

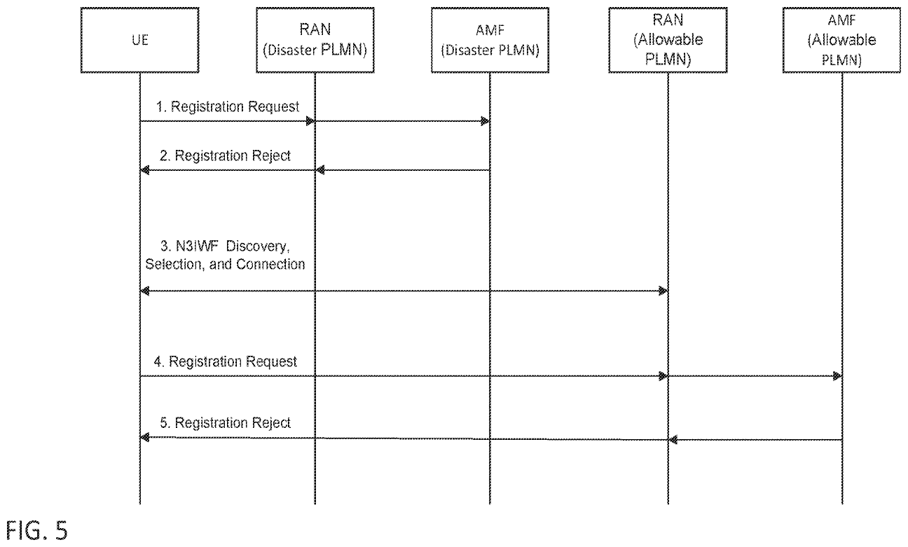

FIG. 5 illustrates a procedure where the UE receives information from a Disaster PLMN to help discover an N3IWF of the HPLMN or EHPLMN and then registers to the HPLMN or EHPLMN.

In step 1, the UE sends a Registration Request to the AMF of the disaster PLMN. The UE indicates to the AMF that the UE is registering for disaster roaming.

In step 2, the AMF determines that the UE maybe able use non-3GPP access to register with the UE's HPLMN or an EHPLMN of the UE in the UE's current location. The AMF may send a registration reject message to the UE and as described above, the AMF may indicate to the UE that the UE is rejected because the UE may be able to register with the UE's HPLMN or EHPLMN in the UE's current location. As described above, the AMF may provide the UE with Disaster Level information that the UE may use to assist in constructing an FQDN of an N3IWF of the UE's HPLMN or EHPLMN that is available in the current location.

In step 3, the UE constructs an FQDN of an N3IWF of the UE's HPLMN or EHPLMN, discovers the N3IWF, selects the N3IWF, and connects to the N3IWF. If the UE is unable to connect to the N3IWF, the UE may repeat step 1 and also provide an indication that the UE is unable to connect to the N3IWF of the HPLMN or EHPLMN of the UE's. The request may also include information about previously failed registration attempts. The information may include what network rejected the UE, was RAT was used for rejected registration attempt, what time the registration was attempted, and UE location information.

In step 4, the UE sends a Registration Request (via the N3IWF) to the HPLMN or EHPLMN.

In step 5, the UE receives a Registration Accept message from the HPLMN or EHPLMN.

### UE Actions when the Disaster Ends

As illustrated in step 5 of FIG. 1, when the UE is connected to a PLMN during a disaster situation (e.g., the UE is connected to a PLMN that is not an Allowable PLMN), the UE may receive a message that notifies the UE that the disaster condition is over.

In a first example, the UE may receive a NAS Message notifying the UE the disaster condition is over. The NAS notification may further include a time period within which the UE must de-register from the network. Alternatively, the NAS Message may indicate that the disaster situation is still in place, but the UE is now in an area where the disaster no longer applies. The message may cause the UE to de-register from the network, but the UE may be allowed to make another disaster connection if the UE moves back into the area where the disaster condition applies.

In a second example, the UE may receive an RRC Message notifying the UE the disaster condition is over. The RRC notification may further include a time period within which the UE must de-register from the network. Alternatively, the RRC Message may indicate that the disaster situation is still in place, but the UE is now in an area where the disaster no longer applies. The message may cause the UE to de-register from the network, but the UE may be allowed to make another disaster connection if the UE moves back into the area where the disaster condition applies. Instead of de-registering from the network, the message may additionally indicate that the UE that the network is steering the UE to hand over to a cell that is in an Allowable PLMN. When this approach is used, the network can gradually move (e.g., handover) UEs to Allowable PLMNs of the UE, thus avoiding a situation where many UE's attempt to leave one network and connect to another network at the same time.

The NAS or RRC message that notifies the UE that the disaster condition is over may be initiated by the network (e.g., when the network is notified by the OAM system that the condition is over). Alternatively, the UE may send a NAS or RRC message to the network to query, or check, about the status of the disaster situation. For example, the UE may send a NAS message to the network that includes one or more PLMN ID's and the request may indicate that the UE wants to know whether the PLMN IDs are in a disaster situation. Alternatively, the request may include no explicit PLMN IDs, and the network may determine the UE's home network based on the UE's identity (e.g., SUCI). The network may then query the UE's home network to see if the UE should still consider itself a disaster roamer or if the UE should be prompted to perform a new PLMN search because an EHPLMN of the UE is likely to be available. The network may then send a NAS or RRC response to the UE and indicate whether or not the UE should try a new PLMN search. If the network indicates to the UE that the disaster situation is still active, the network may further include a back-off timer or an expected disaster resolution time in order to decrease the frequency with which the UE checks the status of the disaster situation. The indication to the UE that the disaster is over may originate in the UE's home network and come to the UE via an SMS message.

The network may further send the disaster notification to the UE in response to any NAS message (e.g., Registration or Service Request). The notification may indicate that the disaster situation is, or is not, still in place. Informing the UE in a NAS response that the disaster situation is still in place has the benefit of decreasing the frequency with which the UE checks the disaster situation.

In a third example, the UE may detect that the disaster PLMN that it is connected to is no longer broadcasting a disaster indication or is explicitly broadcasting an indication that the disaster is over. The broadcast may further include a value that the UE may use to determine at what time is allowed to begin searching for, or connecting to, an Allowable PLMN.

In a fourth example, the UE may detect that an Allowable PLMN is no longer broadcasting a disaster indication or is explicitly broadcasting an indication that the disaster is over. The broadcast may further include a value that the UE may use to determine at what time is allowed to begin searching for, or connecting to, an Allowable PLMN. The UE may have been configured to periodically check if the disaster condition in the Allowable PLMN(s) has been cleared. The UE may have been previously configured by an Allowable PLMN with a time period that the UE should use when determining how frequently to check or the UE may have been configured by the Disaster PLMN with a time period that the UE should use when determining how frequently to check.

The De-Registration message may be enhanced to allow the UE to indicate that it is de-registering because it has detected that the disaster is over or because it has found an Allowable PLMN that is not operating in a disaster mode.

An RRC message may be enhanced to allow the UE to indicate that it is de-registering because it has detected that the disaster is over or because it has found an Allowable PLMN that is not operating in a disaster mode. The message may further indicate to the RAN Node what cell of the Allowable PLMN it would like to hand over to and a handover procedure may be initiated by the network.

### Considering Access Class and Access Identities when Registered

When the UE is registered to the network and in idle mode, it may detect if UEs for which a disaster condition applies (Access Identity Number 3) are barred from the network. If the UE does detect this barring condition, the UE may interpret this as an indication that the disaster condition is over or at least that the PLMN is no longer willing to serve disaster roamers. This indication will cause the UE to restart PLMN selection and/or de-register (e.g., when a UE detects that its disaster roamers are barred, the UE may still be allowed to connect to the network for the purpose of sending a de-registration; the RAN mode may allow disaster roamers to establish RRC connections with cause code mo-signaling (Mobile Originated Signaling)).

### Additional Considerations for Detecting the End of a Disaster Situation

In order to avoid situations where many devices simultaneously attempt to return to a network when a disaster is over, then network that was experiencing the disaster may continue to broadcast a disaster indication for a time period even after the disaster situation is over. This may be done in order to discourage devices from immediately attempting to connect to the network. As described earlier, the other networks may be notified that the disaster situation is over and the other networks may notify their disaster roamers that the disaster is over and the other networks may send the disaster roaming UEs messages (e.g., NAS or RRC) to notify the UEs that the disaster condition is over. The notification message may include PLMN IDs of networks that are not in a disaster situation. If any of the PLMN IDs in the notification are an Allowable PLMN or EHPLMN of the UE, then the UE may de-register from the network and connect to a PLMN that was identified in the notification.

If the notification is sent in NAS message, the notification may be sent to the UE in a De-Registration Request, in response to a Registration Request (e.g., an initial or mobility registration), in a UE Configuration Update Command, or in response to a Service Request.

If the UE received the notification when the UE is in the CM-IDLE state and if any of the PLMN IDs in the notification are an Allowable PLMN or EHPLMN of the UE, the notification may cause the UE to De-Register from the network and connect to a PLMN that was identified in the notification.

If the UE received the notification when the UE is in the CM-CONNECTED state, the notification may further include a random or UE specific timer that indicates how long the UE may wait before deregistering from the network. If any of the PLMN IDs in the notification are an Allowable PLMN or EHPLMN of the UE, then the MT part of the UE may invoke an AT Command to indicate to the ME part of the UE that the disaster is over and the UE must de-register from the current network within a time period. The MT may then terminate existing PDU sessions and the UE may de-register from the network and connect to a PLMN that was identified in the notification.

Note that, in the examples above, the network that is no longer in a disaster may still be broadcasting an indication that the disaster situation remains. The network may still be indicating failure in order to avoid a flood of UEs attempting to register. However, since the UE was notified by another network that the disaster condition no longer applies, the UE may be permitted to attempt to Register with any of the PLMN IDs in the notification are an Allowable PLMN or EHPLMN of the UE.

Note that, in the examples above, all NAS messages may be delivered to the UE over a non-3GPP access network via an N3IWF. Also, all PDU Sessions may be MA-PDU Sessions.

Note that, in the example above, the notification that the disaster is over may be conveyed to the UE as part of a NAS response cause code.

### Dealing with CM-IDLE UEs when the Disaster Ends

When the disaster ends, a UE that is a disaster roamer may be in the RM-REGISTERED and CM-IDLE states. When the disaster ends, it is desirable to minimize the amount of signaling that is required for the network to inform the UE that that disaster is over and to move the UE to the RM-DEREGISTERED state. Once the UE is in the RM-DEREGISTERED state, the UE may attempt to select an EHPLMN or HPLMN and initiate the Initial Registration procedure with the HPLMN or EHPLMN.

A disaster roamer may receive a Disaster Over Paging Identity Flag, or value, from the disaster PLMN. The Disaster Over Paging Identity Flag may be provided to the UE, by the network (e.g., AMF), in the Registration Accept message or a UE Configuration Update message. The format of the Disaster Over Paging Identity Flag may be a 5G-S-TMSI. The network may assign the same Disaster Over Paging Identity Flag to more than one UE. As described above, the UE may indicate to the network that the UE is registering for disaster roaming and this indication may be used by the network to determine to send the Disaster Over Paging Identity Flag to the UE.

When the AMF receives a notification that the disaster is over, the AMF may send a paging request for the UE to a RAN node. The N2 connection between the RAN node and AMF that is associated with the UE may be used to send the request to the RAN node. The UE Paging Identity that was included in the UE Paging Request may be the Disaster Over Paging Identity Flag that was provided to the UE as described above. Alternatively, the UE Paging Identity that is included in the UE Paging Request may be a reserved value that indicates that the disaster is over.

Upon receiving the UE Paging Request, the RAN node may page the UE at the UE's paging occasion (PO). At the UE's paging occasion (PO), the UE will read the PCH and determine that the network might be attempting to page the UE. The UE may then read the PDSCH or NPDSCH to determine if it is being paged. If the PDSCH or NPDSCH includes the Disaster Over Paging Identity Flag that was previously provided to the UE, then the UE may determine that the disaster is over. The PDSCH or NPDSCH may also include a value that is used by the UE to determine how long to wait before attempting to return to the HPLMN or EHPLMN. For example, the PDSCH or NPDSCH may contain a time value that the UE should use to program a wait time or the PDSCH or NPDSCH may contain a value that is used to derive a time value that the UE should use to program a wait time.

Reception of the Disaster Over Paging Identity Flag and determining that the disaster is over may cause the UE to respond to the network by sending a Deregistration Request to the network. The Deregistration Type information clement in the Deregistration Request may indicate to the network that the request is being sent because the UE has determined that the disaster is over. The Deregistration Accept message from the network to the UE may include a value that is used by the UE to determine how long to wait before attempting to return to the HPLMN or EHPLMN. For example, the Deregistration Accept message may contain a time value that the UE should use to program a wait time or the PDSCH or NPDSCH may contain a value that is used to derive a time value that the UE should use to program a wait time.

Alternatively, when the Disaster Over Paging Identity Flag is in the paging message, the UE may interpret the presence of the Disaster Over Paging Identity Flag as an indication to UE, or to all disaster roamers, that the system information that is associated with disaster roamers and broadcasted by the network has changed and that the UE should read the system information that is associated with disaster roaming and then determine whether or not the disaster is over.

Alternatively, when the AMF sends a UE Paging Request to the RAN with the UE's Disaster Over Paging Identity Flag, the AMF may consider the UE to be implicitly Deregistered. In this alternative, the UE will move to the RM-DEREGISTERED state upon reception of a paging message that includes the UE's Disaster Over Paging Identity Flag. Thus, in this alternative, the UE can avoid sending a Deregistration request to the network.

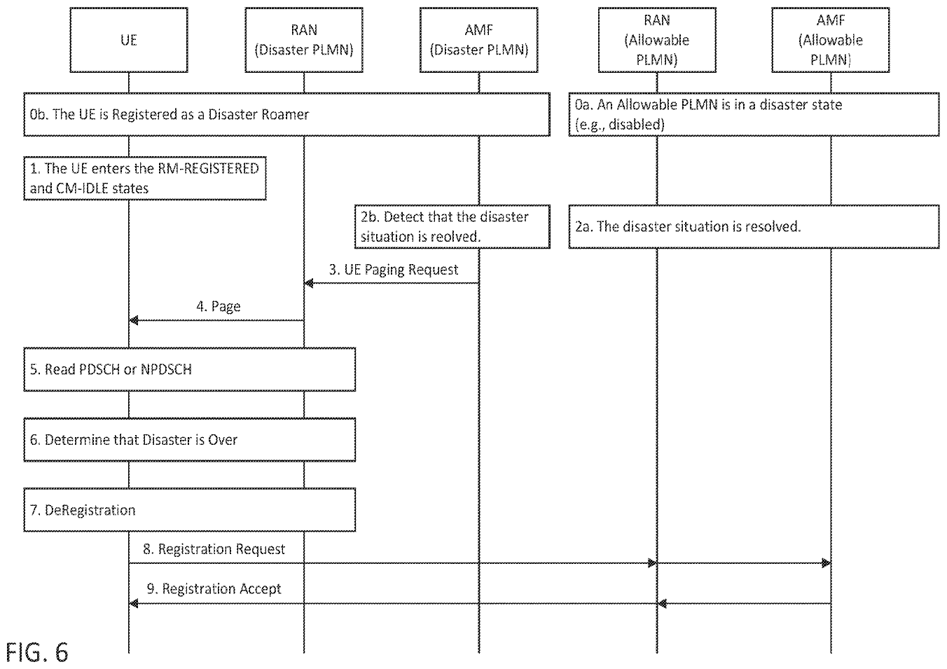

FIG. 6 shows how a UE that is in the RM-REGISTERED and CM-IDLE states may determine that the disaster situation in the EHPLMN is over, deregister from the Disaster PLMN, and Register to the EHPLMN.

In step 0, the EHPLMN is in a disaster state and the UE is registered to a Disaster PLMN. Prior to step 0, the UE would have determined that there is a disaster situation in the EHPLMN and determined to become a disaster roamer. How the UE determined that there is a disaster situation and becomes a disaster roamer is described above.

In step 1, UE is registered to the Disaster PLMN and enters the CM-IDLE state. The UE is now in the RM-REGISTERED and CM-IDLE states.

In step 2a the disaster situation in the UE's EHPLMN is resolved and, in step 2b, the AMF detects that the disaster situation is over in the UE's EHPLMN. The AMF may make this determination when it receives a notification from the OAM system. How the AMF determines that the disaster situation is over in the UE's EHPLMN is further resolved above.

In step 3, the AMF uses the N2 connection between the RAN Node and AMF that is associated with the UE to send a UE Paging Request message to the RAN node. The UE Paging Identity in the request may be set to the Disaster Over Paging Identity Flag as described above.

In step 4, at the UE's PO, the UE monitors (e.g., reads) the PCH and determines that it needs to read the PDSCH or NPDSCH to determine if it is being paged.

In step 5, the UE reads the PDSCH or NPDSCH and detects that the PDSCH or NPDSCH includes the Disaster Over Paging Identity Flag. Alternatively, and as described above, the PDSCH or NPDSCH may include an indication that the network is broadcasting updated disaster information, that a disaster situation is over, or that the network is no longer supporting disaster roamers.

In step 6, the UE determines that the disaster in the EHPLMN is over. This determination may be made based on the presence of the Disaster Over Paging Identity Flag in the PDSCH or NPDSCH. Alternatively, and as described above, this determination may be made based on the UE reading System Information that is broadcasted by the Disaster PLMN. The UE may have been triggered to read System Information that is associated with the Disaster PLMN by one or more indications that were included in the PDSCH or NPDSCH as described as previously described and in step 5 above.

In step 7, the UE Deregisters from the network. The UE may deregister from the network by sending a Deregistration Request to the network with the Deregistration Type information element in the Deregistration Request set to indicate to the network that the request is being sent because the UE has determined that the disaster is over. The UE may then receive a Deregistration Accept message from the network. The Deregistration Accept message may trigger the UE to move to the RM-DEREGISTERED state. Alternatively, and as described above, the UE may choose to not send the Deregistration Request to the network; the determination in step 6 may trigger the UE to consider itself implicitly deregistered and move to the RM-DEREGISTERED. In this alternative, the AMF may consider the UE to be implicitly deregistered after the AMF sends the UE Paging Request in step 3.

In step 8, the UE sends a Registration Request to the EHPLMN, possibly after the expiration of a timer value as described above.

In step 9, the UE receives a Registration Accept from the EHPLMN.

Note that the AMF can use the procedure above to help multiple UEs detect that a disaster situation is over and return to their respective EHPLMNs. Additionally, the AMF can assign the same Disaster Over Paging Identity Flag to multiple UEs. For example, AMF may assign the same Disaster Over Paging Identity Flag to UEs that are associated with the same EHPLMN or requiring the same service types. The AMF may then send an N2 Message to the RAN node that indicates to the RAN node to include the Disaster Over Paging Identity Flag when paging the UEs. The N2 connection message that is used to send this message to the RAN node may not be associated with any single UE. The message may further include multiple UE Identifiers (e.g., UE_ID or IMSI) that need to receive this message. The UE identifiers will be used by the RAN to determine the UEs' paging occasions. The RAN node may also use the UE Identifiers to determine when the Disaster Over Paging Identity Flag needs to be included in the PDSCH or NPDSCH. When the Disaster Over Paging Identity Flag is included in the PDSCH or NPDSCH, it may not be necessary to include any UE specific identifiers in the PDSCH or NPDSCH.

Note that the AMF may be configured to assign a different Disaster Over Paging Identity Flag to certain groups of UEs that are associated with the EHPLMN that is in a disaster situation. The AMF could then choose to execute the above procedure at different times for each group in order to reduce the number of UEs that attempt to return to the EHPLMN at the same time.

Note that paging a UE that is in the RM-REGISTERED and CM-IDLE state in order to cause the UE to soon return, or register, with their EHPLMN is advantageous to waiting for a UE to enter the CM-CONNECTED and then informing the UE that the UE should register with the EHPLMN. The advantage of paging the UE is that it allows the UE to return to the network before UE initiated user plane traffic (e.g., uplink traffic) or network-initiated user plane traffic (e.g., downlink traffic) requires the UE to be in CM-CONNECTED state.

### Distributing PLMN Roamers more Evenly

The UEs RAT Selection procedure may be modified when it detects a disaster condition is over. The modification may be such that the UE prefers non-3GPP access to initially register with the HPLMN or EHPLMN. In other words, the UE may behave as if the NR radio is restricted. If the UE successfully uses the non-3GPP RAT to register with the HPLMN or EHPLMN, then the UE may consider the NR radio to be restricted until the HPLMN or EHPLMN signals to the UE that the NR radio is no longer restricted. If the UE does not successfully use the non-3GPP RAT to register with the HPLMN or EHPLMN, then the UE may consider the NR radio to be no longer be restricted and attempt to use the NR radio to register with the HPLMN or EHPLMN.

### Example Environments

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G.” 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mm Wave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

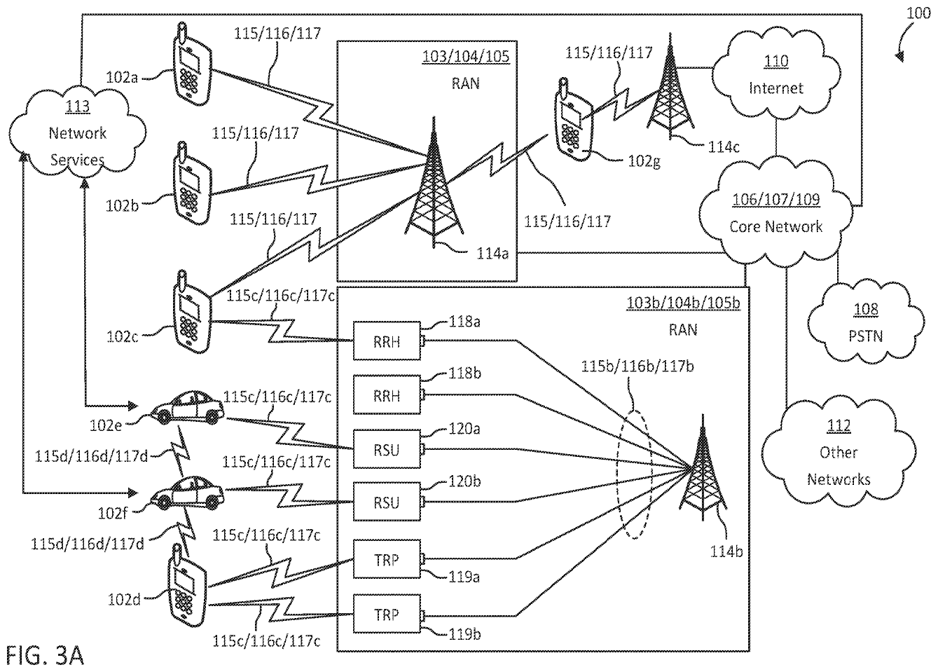

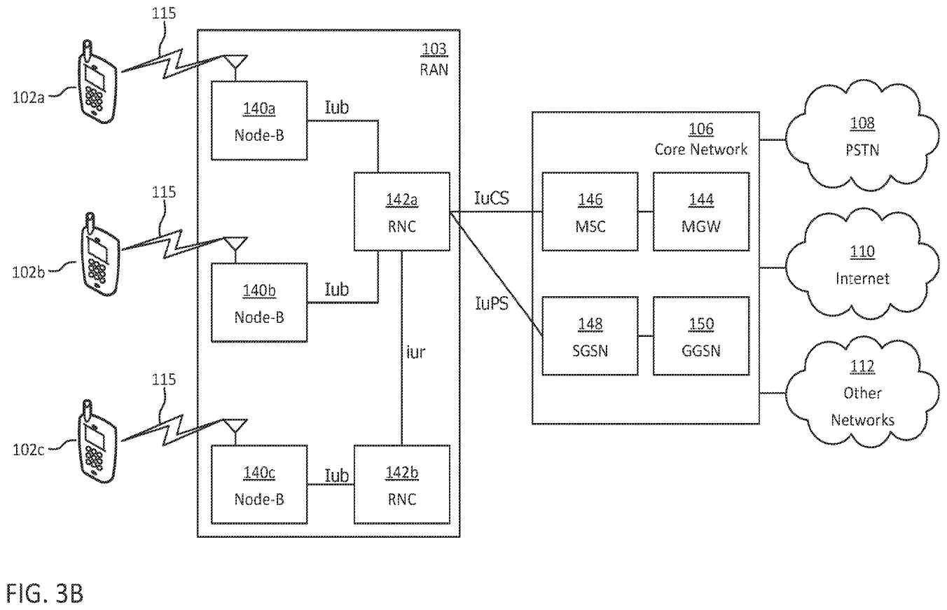

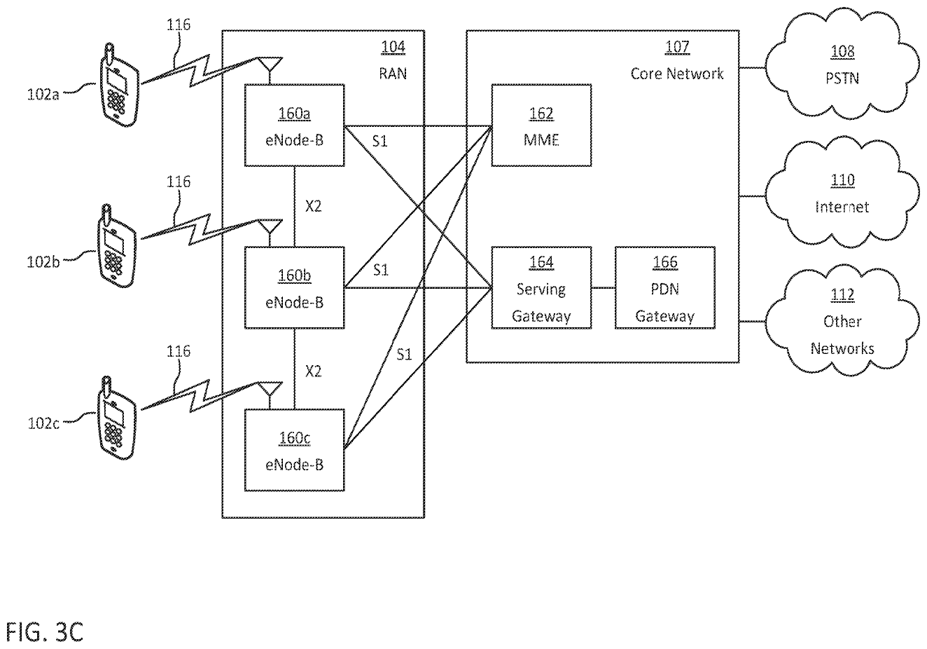

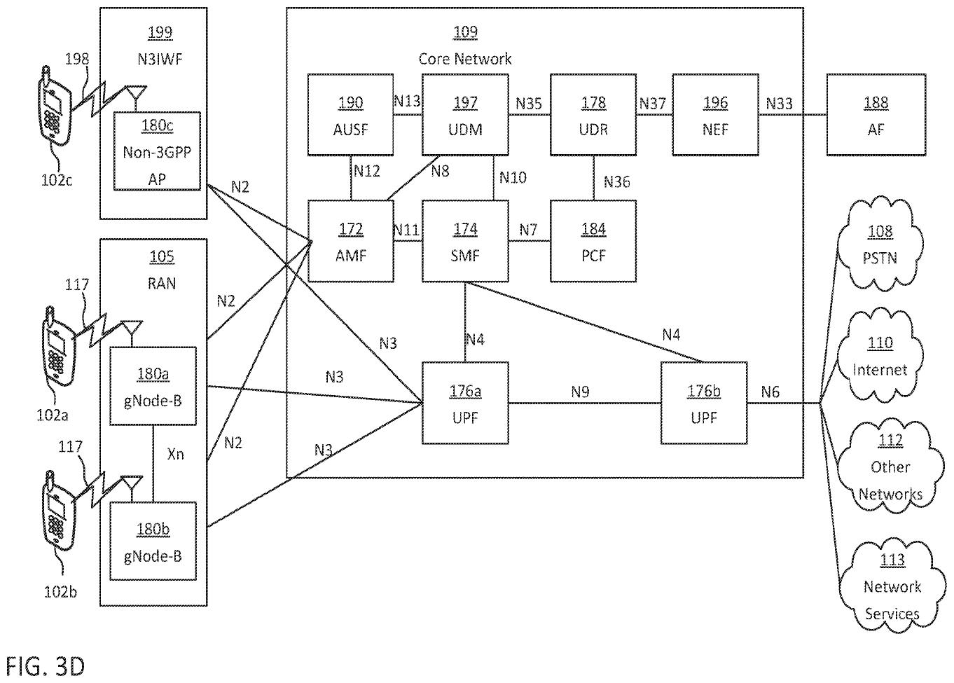

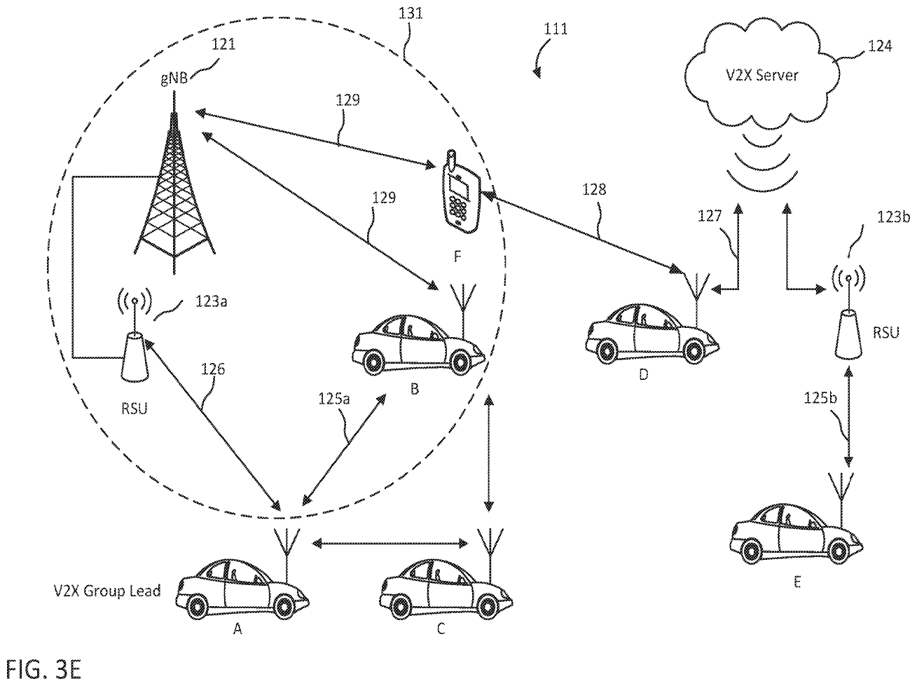

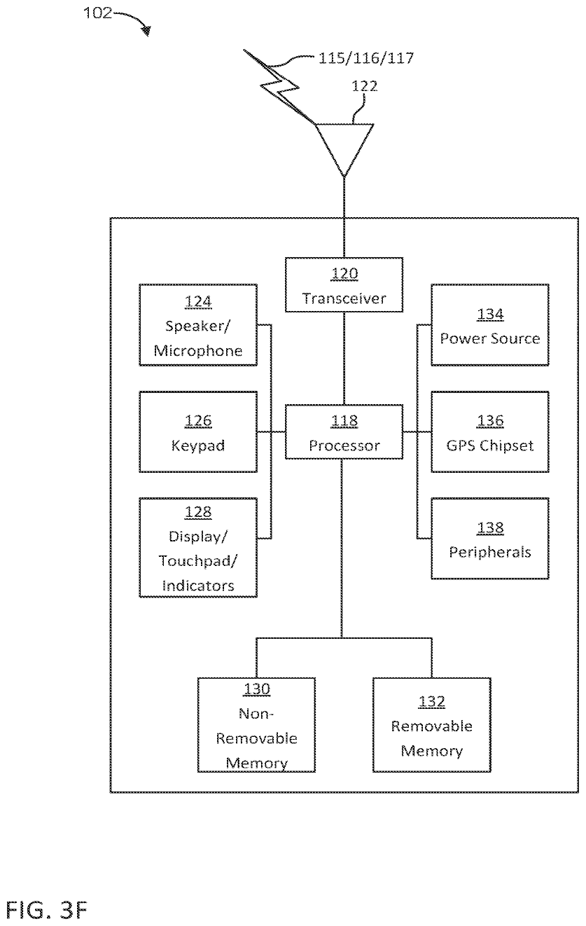

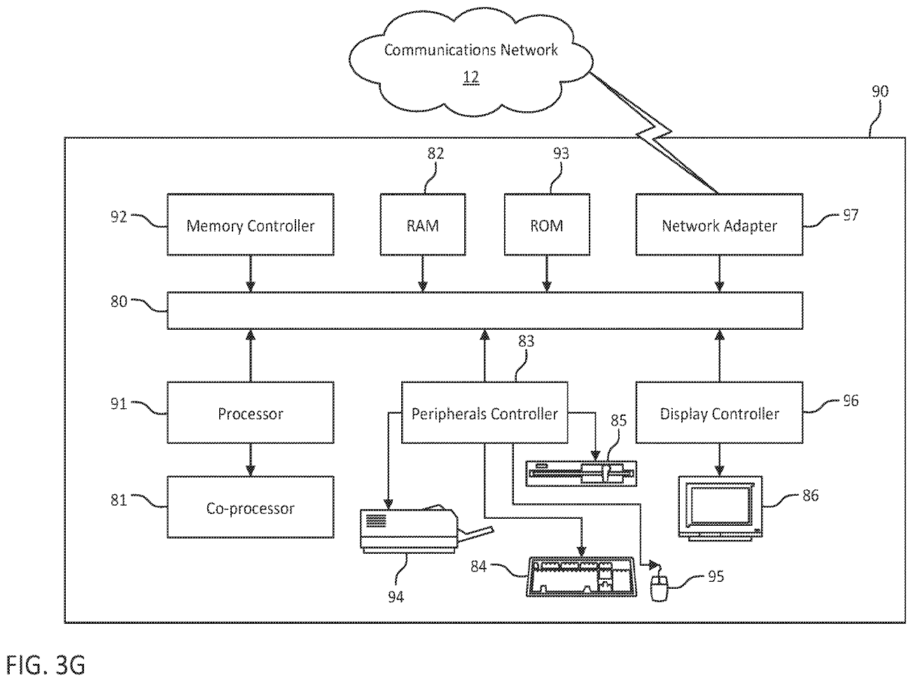

FIG. 3A illustrates an example communications system 100 in which the systems, methods, and apparatuses described and claimed herein may be used. The communications system 100 may include wireless transmit/receive units (WTRUs) 102a, 102b, 102c, 102d, 102c, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

The concepts disclosed herein may be used with any number of WTRUs, base stations, networks, and/or network elements. Each of the WTRUs 102 may be any type of apparatus or device configured to operate and/or communicate in a wireless environment. In the example of FIG. 3A, each of the WTRUs 102 is depicted in FIGS. 3A-E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 3A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102c, and 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 3A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102c, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 3A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 3A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 3A may be configured to communicate with the base station 114a, which may employ a cellular-based radio technology, and with the base station 114c, which may employ an IEEE 802 radio technology.

Although not shown in FIG. 3A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 3B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 3B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 3B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 3B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 3C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 3C, the eNode-Bs 160a, 160b, and 160c may communicate with one another over an X2 interface.

The core network 107 shown in FIG. 3C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 3D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 3D, the gNode-Bs 180a and 180b may communicate with one another over an Xn interface, for example.

The core network 109 shown in FIG. 3D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 3G.

In the example of FIG. 3D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 3D shows that network functions directly connect to one another, however, it should be appreciated that they may communicate via routing agents such as a diameter routing agent or message buses.

In the example of FIG. 3D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 3D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 3D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance, and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 3D, in a network slicing scenario, a WTRU 102a, 102b, or 102c may connect to an AMF 172, via an NI interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, which serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIG. 3A, FIG. 3C, FIG. 3D, and FIG. 3E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 1A-E are provided by way of example only, and it is understood that the subject matter disclosed and claimed herein may be embodied or implemented in any similar communication system, whether presently defined or defined in the future.

FIG. 3E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Roadside Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and Care group members.

WTRUs A, B, C, D, E, and F may communicate with each other over a Uu interface 129 via the gNB 121 if they are within the access network coverage 131. In the example of FIG. 3E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 3E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 3F is a block diagram of an example apparatus or device WTRU 102 that may be configured for wireless communications and operations in accordance with the systems, methods, and apparatuses described herein, such as a WTRU 102 of FIGS. 3A-E. As shown in FIG. 3F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 3F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 3F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 3A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 3F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 3G is a block diagram of an exemplary computing system 90 in which one or more apparatuses of the communications networks illustrated in FIG. 3A, FIG. 3C, FIG. 3D and FIG. 3E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 1A-1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible, or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

### Appendix

TABLE 1
Acronyms

| Acronym | Description |
|---|---|
| AF | Application Function |
| AMF | Access and Mobility Function |
| AUSF | Authentication Function |
| CMAS | Commercial Mobile Alert System |
| DNN | Data Network Name |
| EHPLMN | Equivalent HPLMN |
| ETWS | Earthquake and Tsunami Warning System |
| eMBB | Enhanced Mobile Broadband |
| EU | European Union |
| E-UTRAN | Evolved UMTS Terrestrial Radio Access Network |
| GPRS | General Packet Radio Service |
| GSM | Global System for Mobile Communications |
| GUI | Graphical User Interface |
| HPLMN | Home PLMN |
| LSB | Least Significant Bit |
| KPAS | Korean Public Alert System |
| MA-PDU Session | Multi-Access PDU Session |
| MIB | Master Information Block |
| MO | Mobile Originated |
| MS | Mobile Station |
| MT | Mobile Terminated |
| NAS | Non-Access Stratum |
| NWDAF | Network Data Analytics Function |
| NEF | Network Exposure Function |
| NG RAN | Next Generation RAN |
| NPDSCH | Narrowband Physical Downlink Shared Channel |
| NSSAI | Network Slice Selection Assistance Information |
| N3IWF | Non-3GPP InterWorking Function |
| OAM | Operations and Management |
| OTA | Ove the Air |
| OTT | Over the Top |
| PDU | Protocol Data Unit |
| PDSCH | Physical Downlink Shared Channel |
| PLMN | Public Land Mobile Network |
| PWS | Public Warning System |
| RAN | Radio Access Network |
| RRC | Radio Resource Control |
| SIB | System Information Block |
| SM | Session Management |
| SIM | Subscriber Identity Module |
| SMS | Short Message Service |
| S-NSSAI | Single NSSAI |
| TE | Terminal Equipment |
| TMGI | Temporary Mobile Group Identity |
| TNGF | Trusted Non-3GPP Gateway Function |
| UE | User Equipment |
| UMTS | Universal Mobile Telecommunications Service |
| W-AGF | Wireline Access Gateway Function |
| WEA | Wireless Emergency Alerts |

1-20. (canceled)

21. A wireless transmit/receive unit (WTRU) comprising a processor, a memory, communication circuitry, and computer-executable instructions stored in the memory which, when executed by the processor, cause the WTRU to:
receive configuration information comprising an indication of one or more networks that may be able to serve the WTRU in the event of a disaster in at least a first network associated with the WTRU;
determine a disaster condition in the first network;
detect, based on the configuration information and on broadcast information received from a second network, that the second network is able to provide service to the WTRU, wherein the broadcast information comprises an indication that the second network is able to provide service to disaster roamers;
send, to the second network, a first registration request comprising an indication that the registration request pertains to disaster roaming;
determine that the disaster condition is over; and
based on determining the disaster condition is over, send a second registration request to the first network,
wherein the instructions further cause the WTRU to receive an indication of a second wait time associated with sending the second registration request to the first network.

22. The WTRU of claim 21, wherein causing the WTRU to determine the disaster condition is over further comprises at least one of:
receiving, in response to sending a message to the second network, a non-access stratum (NAS) response message from the second network indicating the disaster condition is over;
receiving a NAS message from the second network indicating the disaster condition is over; or
detecting that broadcast information associated with the second network does not include an indication that the second network is able to provide service to disaster roamers.

23. The WTRU of claim 21, wherein the instructions further cause the WTRU to receive an indication of a first wait time associated with sending the first registration request to the second network.

24. The WTRU of claim 21, wherein the instructions further cause the WTRU to receive the configuration information in a non-access stratum (NAS) message.

25. The WTRU of claim 21, wherein the configuration information comprises a prioritized list of public land mobile networks (PLMNs).

26. The WTRU of claim 21, wherein the instructions further cause the WTRU to store the configuration information in a subscriber identity module (SIM).

27. The WTRU of claim 21, wherein a mobile terminated (MT) part of the WTRU uses an attention (AT) command to send, to a terminal equipment (TE) part of the WTRU, a list of networks that may serve the WTRU in the event of a disaster.

28. The WTRU of claim 21, wherein the instructions further cause the WTRU to provide a graphical user interface displaying a list of networks that may serve the WTRU in the event of a disaster.

29. The WTRU of claim 21, wherein the registration request is a non-access stratum (NAS) message carried in a radio resource control (RRC) message.

30. A method comprising:
receiving, by a wireless transmit/receive unit (WTRU), configuration information comprising an indication of one or more networks that may be able to serve the WTRU in the event of a disaster in at least a first network associated with the WTRU;
determining a disaster condition in the first network;
detecting, based on the configuration information and on broadcast information received from a second network, that the second network is able to provide service to the WTRU, wherein the broadcast information comprises an indication that the second network is able to provide service to disaster roamers;
sending, to the second network, a first registration request comprising an indication that the registration request pertains to disaster roaming;
determining that the disaster condition is over; and
based on determining the disaster condition is over, sending a second registration request to the first network,
wherein the method further comprises receiving, by the WTRU, an indication of a second wait time associated with sending the second registration request to the first network.

31. The method of claim 30, wherein causing the WTRU to determine the disaster condition is over further comprises at least one of:
receiving, in response to sending a message to the second network, a non-access stratum (NAS) response message from the second network indicating the disaster condition is over;
receiving a NAS message from the second network indicating the disaster condition is over; or
detecting that broadcast information associated with the second network does not include an indication that the second network is able to provide service to disaster roamers.

32. The method of claim 30, further comprising receiving, by the WTRU, an indication of a first wait time associated with sending the first registration request to the second network.

33. The method of claim 30, further comprising receiving, by the WTRU, the configuration information in a non-access stratum (NAS) message.

34. The method of claim 30, wherein the configuration information comprises a prioritized list of public land mobile networks (PLMNs).

35. The method of claim 30, further comprising storing, by the WTRU, the configuration information in a subscriber identity module (SIM).

36. The method of claim 30, wherein a mobile terminated (MT) part of the WTRU uses an attention (AT) command to send, to a terminal equipment (TE) part of the WTRU, a list of networks that may serve the WTRU in the event of a disaster.

37. The method of claim 30, further comprising providing, by the WTRU, a graphical user interface displaying a list of networks that may serve the WTRU in the event of a disaster.

38. The method of claim 30, wherein the registration request is a non-access stratum (NAS) message carried in a radio resource control (RRC) message.

39. The method of claim 30, further comprising determining, by the WTRU, that the disaster condition is over based on a broadcast message that is received from the second network.

40. The method of claim 30, wherein the received broadcast information comprises an identifier of the second network.
